(19) United States
(12) Patent Application Publication
(10) Pub. No.: US 2007/0092410 A1
(43) Pub. Date: Apr. 26, 2007

(54) Device for pipetting solution from one plate format to a different plate platform using movable position pipette tips

(76) Inventors: Robert D. Ricker, Middletown, DE (US); Bernd-Walter Hoffman, Karlsruhe (DE); Alan D. Broske, West Chester, PA (US); William E. Barber, Landenberg, PA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/259,857

(22) Filed: Oct. 26, 2005

(51) Int. Cl. B01L 3/02

(52) U.S. Cl. 422/100

(57) ABSTRACT

A pipetting device includes first and second bodies, through which a plurality of pipettes extend. The surface of one of the bodies is free to move relative to the surface of the other body. Relative motion between the two bodies causes an inter-pipette distance exhibited by the pipetting device to vary.

### BACKGROUND

In laboratory settings, it is commonplace to hold fluids in microtiter plates, so that the fluids may be kept track of as they undergo various analytical or other processes. A microtiter plate is a generally planar device that defines a multitude of wells in its upper surface. Each well may store a given volume of fluid for later retrieval.

Generally, a microtiter plate defines 96 or 384 wells, although, in principle, a microtiter plate may define any number of wells. The wells are typically arranged in rows spaced at regular intervals along the surface of the microtiter plate. For a given row of a given microtiter plate, the distance from well to well is constant.

It is sometimes necessary to transfer fluids from the wells of one microtiter plate to the wells of another microtiter plate. Such a transfer may be carried out via a pipetting device that draws fluid from several wells at once. For example, the pipetting device may include eight individual pipettes that are appropriately spaced for introduction into each of eight consecutive wells along a given row. Upon introduction, the fluid in each of the wells is extracted by virtue of the suction generated by the pipetting device. Thereafter, another microtiter plate is introduced to the pipetting device, and the fluid held by the device is delivered into each of eight consecutive wells in the newly introduced microtiter plate.

Not all microtiter plates exhibit identical inter-well spacing. For example, in the context of a standard microtiter plate having 96 wells, it is typical to observe a separation of about 11/32 of an inch from the center of one well to the center of an adjacent well. In contrast, a microtiter plate having 384 wells usually exhibits a distance of about 11/64 of an inch from the center of one well to the center of an adjacent well—a distance that is about one-half of that of the 96-well microtiter plate.

To accommodate the different inter-well spacing described above, the following scheme is generally employed. A technician uses a pipettor having an inter-pipette spacing of 11/32 of an inch for addressing both microtiter plates. When withdrawing fluid from or expelling fluid into a 96-well microtiter plate, the pipettor addresses consecutive wells. On the other hand, when withdrawing fluid from or expelling fluid into a 384-well microtiter plate, the pipettor addresses every other well, and the technician mentally accommodates this by addressing the skipped-over wells during a subsequent withdrawal/expulsion operation.

### SUMMARY

In general terms, the present invention is directed to a pipettor having multiple individual pipettes. The pipettor is configured so that it can vary the spacing from one pipette to a subsequent pipette.

According to one embodiment, a pipettor having a plurality of pipettes includes a first body. The first body has a surface and defines one or more voids through which the plurality of pipettes extends. The pipettor also includes a second body that has a surface and defines one or more voids through which the plurality of pipettes extends. The surface of the second body is free to move relative to the surface of the first body, so that relative motion between the surfaces of the first and second bodies causes an inter-pipette distance exhibited by the plurality of pipettes to vary.

According to another embodiment, a method of adjusting an inter-pipette spacing of a pipetting device includes extending pipettes through at least two bodies. Each of the bodies defines at least one void for passage of the pipettes. The voids are arranged so that the pipettes may travel in at least one dimension, given relative motion between surfaces of the two bodies. Additionally, relative motion is created between the surfaces of the two bodies. The relative motion operates to exert force upon the pipettes, causing the pipettes to travel in the at least one dimension, thereby altering the inter-pipette spacing of the pipette device.

According to yet another embodiment, a pipetting device includes a plurality of pipettes movably coupled to one another. The pipetting device also includes a means for adjusting an inter-pipette distance exhibited by the plurality of pipettes.

### BRIEF DESCRIPTION OF THE DRAWINGS

FIG. 1 depicts a front view of one embodiment of a pipettor.

FIG. 2A depicts a side view the pipettor of FIG. 1, when the second body thereof is in the lower position.

FIG. 2B depicts a side view the pipettor of FIG. 1, when the second body thereof is in the upper position.

FIG. 3A depicts a top view of the first and second plates, as they are positioned relative to one another, when the second body in the upper position.

FIG. 3B depicts a top view of the first and second plates, as they are positioned relative to one another, when the second body in the lower position.

FIG. 4A depicts a top view of an embodiment of the plunger plate of the pipettor of FIG. 1.

FIG. 4B depicts a top view of an embodiment of the plunger plate of the pipettor of FIG. 1 when a pipette is slideably coupled thereto.

FIG. 5 depicts a simplified side view of another embodiment of a pipettor.

FIG. 6 depicts a front view of an embodiment of a pipettor.

FIG. 7A depicts a top view of the first body of the pipettor of FIG. 6, when the second body thereof is in the lower position.

FIG. 7B depicts a top view of the first body of the pipettor of FIG. 6, when the second body thereof is in the upper position.

FIG. 8 depicts a top view of an embodiment of a plunger plate of the pipettor of FIG. 6.

### DETAILED DESCRIPTION

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

The figures herein are not drawn to scale. The size of certain features has been exaggerated in order to allow for ease of discussion. Also, certain commonplace and well-understood features and/or components have been omitted to permit for clear, understandable drawings and discussion.

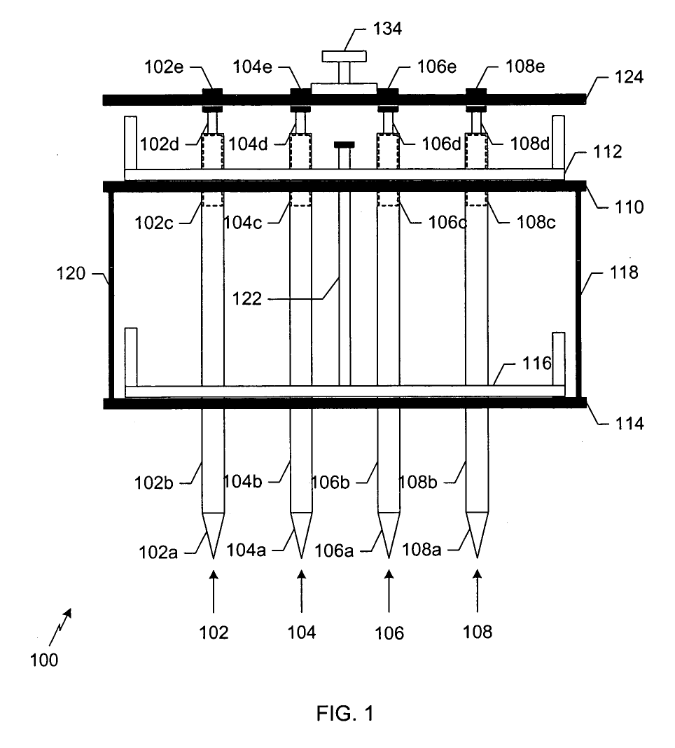

According to one embodiment, FIG. 1 depicts a pipettor 100 that includes four individual pipettes 102-108. Although the pipettor 100 of FIG. 1 is depicted as including four pipettes 102-108, the pipettor 100 may, in principle, include any number of pipettes. Each of the pipettes 102-108 includes a tip 102a-108a, a barrel 102b-108b, a plunger 102c-108c, a plunger rod 102d-108d, and a plunger cap 102e-108e.

As depicted in FIG. 1, the pipettes 102-108 are arranged in a substantially linear fashion, and exhibit a substantially uniform inter-pipette distance. According to one embodiment, the distance exhibited from the center of one pipette tip 102a-108a to the center of an adjacent tip 102a-108a is about 11/32 of an inch—a distance corresponding to a standard 96-well microtiter plate. According to another embodiment, the distance exhibited from the center of one pipette tip 102a-108a to the center of an adjacent tip 102a-108a is about 11/64 of an inch—a distance corresponding to a standard 384-well microtiter plate.

The pipettes 102 and 108 extend through channels defined in a first body 110 and a second body 112. According to one embodiment, the first and second bodies are fashioned as plates. The pipettes 102 and 108 also extend through third and fourth bodies 114 and 116, which are similar in construction to the first and second bodies 110 and 112, respectively.

According to one embodiment, the first and third bodies 110 and 114 are rigidly coupled to one another by members 118 and 120. Similarly, the second and fourth bodies 112 and 116 are coupled to one another by an adjustment rod 122.

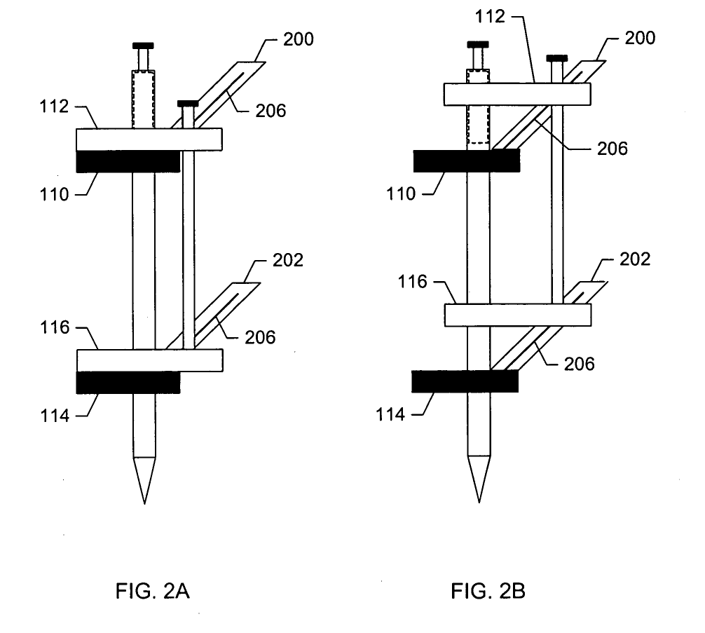

Turning to FIGS. 2A and 2B, it can be seen that ramp members 200 and 202 are joined at either end of the first and third bodies 110 and 114, respectively. The ramp members 200 and 202 have a groove or track 206 extending along their respective outer edge. The second and fourth bodies 112 and 116 mate with the track 206, and are thereby slideably joined to the ramp members 200 and 202. Therefore, the second and fourth bodies 112 and 116 may slide upwardly (as shown in FIG. 2B) and downwardly (as shown in FIG. 2A) along their respective ramp members 200 and 202. The adjustment rod 122 may be driven in an upward or downward direction to cause the sliding motion of the second and fourth bodies 112 and 116 along their respective ramp 200 and 202.

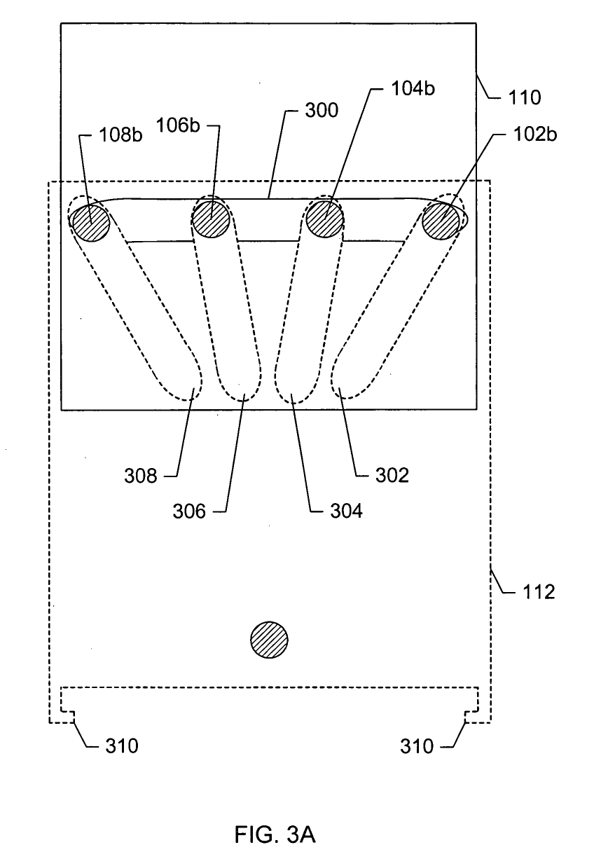

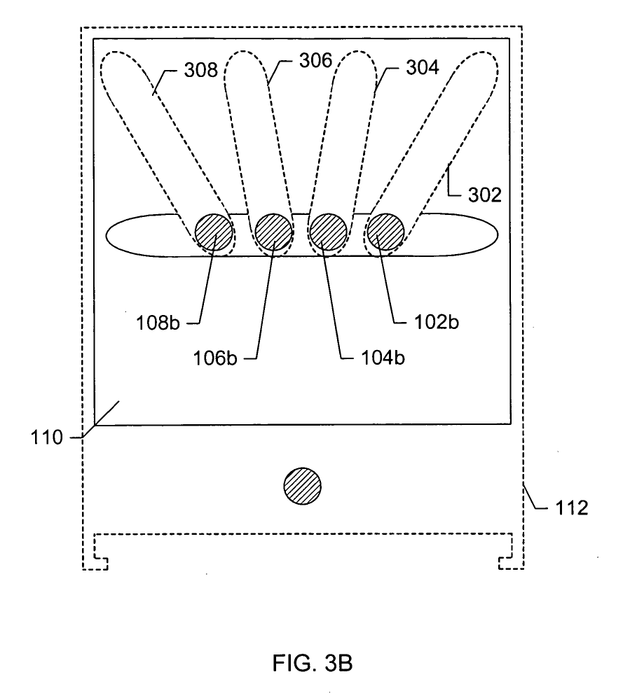

FIG. 3A depicts the first and second bodies 110 and 112, from a top view, as they are positioned relative to one another when the second body 112 has been slid up the ramp 200. The structural features corresponding to the first body 110 are depicted using a solid line, while the structural features corresponding to the second body 112 are depicted using a dashed line. As can be seen from FIG. 3A, the first body 110 includes an elongated, substantially linear channel 300. The pipette barrels 102b-108b are shown in cross-section extending through the channel 300. The channel 300 provides one degree of freedom for the pipette barrels 102b-108b, meaning that they are free to exercise lateral movement.

The second body 112 defines four elongated, generally linear channels 302-308. Each of the pipette barrels 102b-108b extends through the channels 302-308 defined in the second body 112. Therefore, each pipette barrel 102b-108b extends through a channel in each of the first and second bodies 110 and 112. (Pipette barrel 102b extends through channel 300 and channel 302. Pipette barrel 104b extends through channel 300 and channel 304, and so on.) As can be seen from FIG. 3A, the channels 302-308 defined in the second body 112 extend in two dimensions, in a generally fanned-out arrangement.

According to one embodiment, brackets 310 are disposed toward the rear of the second body 112. The brackets 310 may be joined to the second body 112 or may be integral thereto. The brackets 310 mate with the grooves 206 in the ramp member 200, and permit the aforementioned sliding action.

FIG. 3B depicts, from a top view, the relative positions of the first and second bodies 110 and 112, when the second body 112 has been slid down the ramp 200. Again, the structural features corresponding to the first body 110 are depicted using a solid line, while the structural features corresponding to the second body 112 are depicted using a dashed line. By virtue of sliding the second body 112 down the ramp member 200, the second body is translated in a forward direction (as well as downwardly). Consequently, as the second body 112 slides downwardly, the channels 302-308 defined by the second body exert a force upon the pipette barrels 102b-108b, causing them to move inwardly, as shown in FIG. 3B. Hence, the inter-pipette spacing is altered.

From the foregoing, it is clear that the orientation of the channels 302-208 may be “flipped,” meaning that they may be arranged in generally “fanned-in” shape. (This reverses the effect of lowering or raising the second and fourth bodies 112 and 116. Therefore, when the second and fourth bodies 112 and 116 are elevated, the pipettes 102-108 exhibit a narrow inter-pipette spacing, and vice versa). According to one embodiment, the channels 302-308 may be curvilinear, so that a given quantum of vertical displacement of the second and fourth bodies 112 and 116 results in varying degrees of alteration of inter-pipette spacing.

As mentioned previously, the third and fourth bodies 114 and 116 are identical in construction to that of the first and second bodies 110 and 112. The third and fourth bodies 114 and 116, therefore, perform the same function as just described with reference to the first and second bodies 110 and 112. According to one embodiment, the third and fourth bodies 114 and 116 are absent. Per such an embodiment, the longitudinal axes of the various pipettes 102-108 may stray from orthogonality with the first and second bodies 110 and 112 (additionally, the pipettes 102-208 may no longer exhibit substantial parallelism). In this manner, the conical pipette tips 102a-108a may be brought into greater proximity than would otherwise be possible. According to another embodiment depicted in the foregoing figures, the third and fourth bodies 114 and 116 are present, and serve the purpose of ensuring that the pipettes remain substantially vertical as the second and fourth bodies 112 and 116 slide along their respective ramps.

Because alteration of the inter-pipette spacing is dependent upon relative motion between the first and second bodies 110 and 112 (e.g., the second body 112 slides up and down the ramp member 200, while the first body remains static relative to the ramp 200), the various members of the pipettor 100 are fabricated from a low-friction material, according to one embodiment. For example, the members may be constructed from Teflon® or another suitable material.

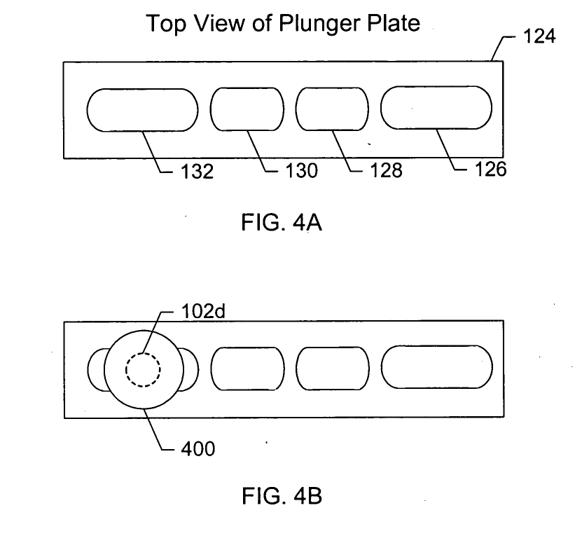

Returning to FIG. 1, it can be seen that each of the pipettes 102-108 is slideably coupled at their proximal end to a plunger plate 124. Turning to FIG. 4A, which depicts the plunger plate 124 from a top view, it can be seen that four elongated, substantially linear channels 126-132 are defined by the plunger plate 124. Each channel 126-132 permits for lateral movement of the pipettes 102-108, which is a consequence of the relative motion between the first and second bodies 110 and 112 and/or the relative motion between the third and fourth bodies 114 and 116. According to one embodiment, the plunger plate 124 may define a single elongated channel, instead of four separate channels 126-132.

According to one embodiment each plunger cap 102e-108e may include two washers: one disposed atop the plunger plate 124, and one disposed below the plunger plate 124. The washer disposed below the plunger plate 124 transfers downward force from the thumb plate 134 to the plungers, so that downward force upon the thumb plate 134 results in a downward movement of the plungers 102c-108c. The washer disposed above the plunger plate 124 transfers upward force from the thumb plate 134 to the plungers, so that upward force upon the thumb plate 134 results in an upward movement of the plungers 102c-108c. FIG. 4B depicts a top view of the plunger plate 124. Therein, a washer 400 is can be seen. The washer 400 is joined to the plunger rod 102d.

In operation, the pipettor 100 may be used in the following way, for example. Initially, the adjustment rod 122 may be placed in a downward position, so that the second body and fourth body 112 and 116 are proximate the first and third bodies 110 and 114, respectively (i.e., are in the downward position shown in FIG. 2A). Thus, the pipette tips 102a-102d exhibit a narrow inter-pipette spacing, appropriate for addressing a 384-well microtiter plate. The pipette tips 102a-102d are positioned so that they enter consecutive wells along a given row of the 384-well microtiter plate. The thumb plate 134 is elevated, thereby generating a suctional force and withdrawing fluid from the various wells. Next, the adjustment rod is elevated, so that the second and fourth bodies 112 and 116 slide upwardly along their respective ramps and arrive at the upward position shown in FIG. 2B. Accordingly, the pipette tips 102a-102d exhibit a wide inter-pipette spacing, appropriate for addressing a 96-well microtiter plate. The pipette tips 102a-102d are positioned so that they enter consecutive wells along a given row of the 96-well microtiter plate. Finally, the thumb plate 134 is depressed, thereby generating an expulsionary force and expelling fluid into the consecutive wells.

Certain modifications of the foregoing embodiments are of note. A casing may enclose the members depicted in the foregoing figures. For example, according to one embodiment, a casing is coupled to static members, such as the first and/or third bodies 110 and 114, and may surround the pipettes 102-108, providing for protrusion of the pipette tips 102a-108a, but otherwise enclosing and protecting the pipette barrels 102b-108b, and moving elements, such as the second and fourth bodies 112 and 116. Also, according to another embodiment, suctional and expulsionary forces are generated by a pump that is in fluid communication with the various pipettes. Per such an embodiment, the pipettes do not include a plunger 102c-108c, plunger rod 102d-108d, plunger cap 102e-108e, plunger plate 124, or thumb plate 134. Instead, a pump provides the aforementioned forces, and may be controlled by control mechanisms associated therewith.

As an alternative embodiment, the first and third bodies 110 and 114 may define channels that have a smaller pitch than the pitch exhibited channels within the second and fourth bodies 112 and 116. Thus, relative motion between the first/third 110/114 and second/fourth bodies 112/116 alters the inter-pipette spacing. Of course, such an arrangement is suitable with a two-dimensional array of pipettes, as well.

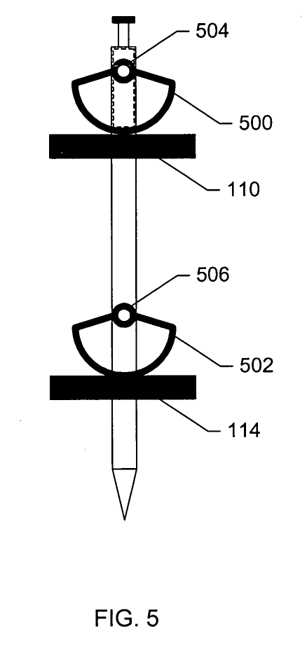

FIG. 5 depicts a simplified illustration of another embodiment of the aforementioned pipettor. In the embodiment of FIG. 5 (simplified side view), the first and third bodies 110 and 114 remain unaltered. However, the second and fourth bodies 500 and 502 are altered, in that they have been “rolled” into an arcuate or partially circular surface. Thus, if “flattened,” the second and fourth bodies 500 and 502 would appear as previously described, including possessing the generally fanned-out channel pattern depicted in FIGS. 3A and 3B. Thus, rotation of the second bodies about their respective axes 504 and 506, results in a widening and/or narrowing of the inter-pipette spacing (rotation in one direction corresponds to narrowing, while rotation in the opposite direction corresponds to widening), for reasons previously described. According to this embodiment, the relative motion between the first and second bodies 110 and 500, for example, occurs between their respective surfaces, i.e., a velocity is exhibited between the surface of the second body 500 and the surface of the first body 110 while the second body 500 rotates.

According to one embodiment, the axes 504 and 506 may be threaded. A threaded two-pronged rod mates with the threaded axes 504 and 506, so that a thrusting action of the rod inwardly toward the axes 504 causes the second and fourth bodies 500 and 502 to rotate in one direction, while a withdrawing action of the rod causes the second and fourth bodies to rotate in the other direction 506.

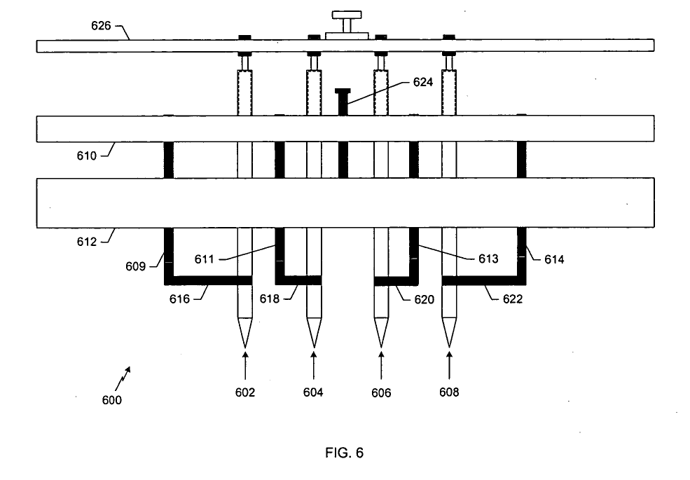

According to another embodiment, FIG. 6 depicts a pipettor 600 that includes four individual pipettes 602-608. Although the pipettor 600 of FIG. 6 is depicted as including four pipettes 602-608, the pipettor 600 may, in principle, include any number of pipettes. The pipettes 602-608 depicted in FIG. 6 include the same components as those described previously. Therefore, their various components are not delineated again.

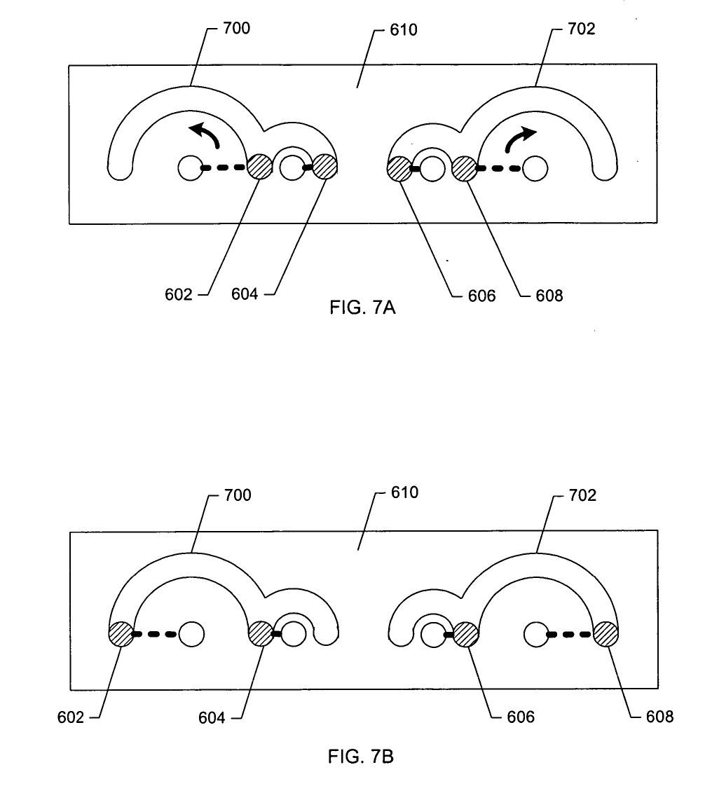

The pipettor 600 includes a first body 610 and a second body 612. Each of the pipettes 602-608 extends through channels defined by the first and second bodies 610 and 612 (the channels are depicted in FIGS. 7A and 7B). Four threaded rods 609-614 extend through the second body 612 and are rotatably coupled to the first body 610. The second body 612 defines four channels—one channel for each of the threaded rods 609-614 to pass through (the channels are depicted in FIGS. 7A and 7B). The channels through which the threaded rods 609-614 extend are also threaded.

The second body 612 is free to translate in an upward and/or downward direction along the threaded rods 609-614. As the second body 612 travels upwardly or downwardly, the threaded channels and threaded rods 609-614 cooperate to exert a rotational force upon the rods 609-614. Hence, the rods 609-614 rotate. The degree of rotation of each rod is determined by the vertical displacement of the second body and by the pitch of the threading of each rod 609-614. Thus, according to one embodiment one or more of the rods 609-614 may rotate through differing angles, given the same vertical displacement of the second body 612. According to the embodiments depicted herein, however, each of the rods 609-614 exhibits the same angular displacement, given a particular vertical displacement of the second body 612.

Each of the threaded rods 609-614 is coupled to a pipette 602-608 by a corresponding connecting rod 616-622. The various connecting rods 616-622 may be integral with the threaded rods 609-614, or may be separate members joined thereto. By virtue of the connecting rods 616-622, rotation of the threaded rods 609-614 results in a concomitant revolution of the pipettes 602-608 about the threaded rod 609-614 to which each pipette 602-608 is coupled. Accordingly, relative motion between the two bodies 610 and 612 results in a revolution of the pipettes 602-608, which alters their inter-pipette spacing.

FIGS. 7A and 7B depict the first and/or second bodies 610 and 612 (their construction is identical). For the sake of discussion, FIGS. 7A and 7B are described with reference to the first body 610. FIG. 7A depicts a top view of the first body 610 and a cross-sectional view of the pipettes 602-608, as they appear relative to one another when the second body is in its lower position (i.e., the position that is depicted in FIG. 6). When the second body 612 is in its lower position, the pipettes experience a narrowed inter-pipette distance.

As can be seen from FIG. 7A, the first body defines two channels 700 and 702. Each channel permits for the revolutionary movement experienced by the pipettes as the second body translates upwardly and/or downwardly. The shape and number of channels 700 and 702 is a function of the aforementioned chosen thread pitch(es), and length(s) of connecting rods 616-622, and may therefore vary.

As the second body 612 is elevated, connecting rods 616 and 618 rotate in the counter-clockwise position, as viewed from above, while connecting rods 620 and 622 rotate in the clockwise direction, also as viewed from above. Consequently, the pipettes 602-608 achieve a widened inter-pipette spacing (as shown in FIG. 7B), when the second body 612 is elevated. As was the case with the previous embodiments, raising and/or lowering of the second body 612 may be accomplished via an adjustment rod 624 that is coupled thereto.

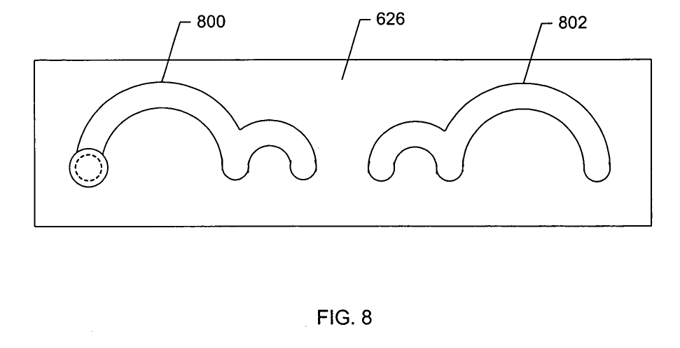

FIG. 8 depicts a top view of the plunger plate 626, which serves the same purpose as the plunger plate 124 described with reference to the aforementioned embodiments of FIGS. 1-7. Like the previously mentioned plunger plate 124, the plunger plate 626 of FIG. 8 includes channels 800 and 802 to permit the revolutionary motion experienced by the pipettes 602-608, in response to the relative motion of the first and second bodies 610 and 612. Again, the shape and number of channels 800 and 802 is a function of the aforementioned chosen thread pitch(es), and length(s) of connecting rods 616-622, and may therefore vary. The channels 800 and 802 are identical in shape to those of the first and second bodies 610 and 612. Also, the pipettes 602-608 are slideably coupled to the plunger plate 626 in a manner similar to that described previously with respect to plunger plate 124.

The various embodiments described above are provided by way of illustration only and should not be construed to limit the invention. Those skilled in the art will readily recognize various modifications and changes that may be made to the present invention without following the example embodiments and applications illustrated and described herein, and without departing from the true spirit and scope of the present invention, which is set forth in the following claims.

Furthermore, in the foregoing detailed description, various features are occasionally grouped together in a single embodiment for the purpose of streamlining the disclosure. This method of disclosure is not to be interpreted as reflecting an intention that the claimed embodiments of the subject matter require more features than are expressly recited in each claim. Rather, as the following claims reflect, inventive subject matter lies in less than all features of a single disclosed embodiment. Thus, the following claims are hereby incorporated into the detailed description, with each claim standing on its own as a separate preferred embodiment.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims.

1. A pipettor including a plurality of pipettes, the pipettor comprising:
a first body defining one or more guides through which the plurality of pipettes extend, the first body having a surface; and
a second body defining one or more guides through which the plurality of pipettes extend, the second body having a surface free to move relative to the surface of the first body, so that relative motion between the surfaces of the first and second bodies causes an inter-pipette distance exhibited by the plurality of pipettes to vary.

2. The pipettor of claim 1, wherein the second body is slideably coupled to a member that is fixedly attached to the first body, so that the relative motion causing the variance in inter-pipette distance is caused by sliding of the second body along said member.

3. The pipettor of claim 1, wherein the first body defines one guide that is elongated and substantially linear, the plurality of pipettes extending through the elongated and substantially linear guide.

4. The pipettor of claim 1, wherein the second body defines a quantity of guides equal in number to a quantity of pipettes included in the pipettor.

5. The pipettor of claim 4, wherein the guides defined by the second body extend in a fanned-out or fanned-in arrangement.

6. The pipettor of claim 4, wherein the second body is substantially planar.

7. The pipettor of claim 4, wherein the second body is at least partially substantially arcuate.

8. The pipettor of claim 1, additionally comprising a plurality of rods extending between the first and second bodies, the plurality of rods being rotatably attached to the first body.

9. The pipettor of claim 8, wherein the second body defines a plurality of threaded channels, wherein each of the rods are threaded and extend through one of the channels defined by the second body, and wherein the motion of the second body along a longitudinal axis of the rods causes the rods to rotate.

10. The pipettor of claim 9, wherein each of the rods is coupled to a pipette, so that rotation of a given rod causes rotation of the pipette coupled thereto.

11. A method of adjusting inter-pipette spacing of a pipetting device, the method comprising:
extending pipettes through at least two bodies, each of which defines at least one guide for passage of the pipettes, the guides being arranged so that the pipettes may travel in at least one dimension, given relative motion between surfaces of the two bodies; and
allowing relative motion between the surfaces of the two bodies, the relative motion operating to exert force upon the pipettes, causing the pipettes to travel in the at least one dimension, thereby altering the inter-pipette spacing of the pipette device.

12. The method of claim 11, wherein the relative motion between the surfaces of the two bodies comprises translation of one body, relative to another.

13. The method of claim 11, wherein the relative motion between the surfaces of the two bodies comprises rotation of a first of the two bodies, so that the surface of the first body exhibits a velocity relative to a second of the two bodies.

14. The method of claim 11, wherein the force exerted upon the pipettes substantially corresponds to an equal and opposite force exerted upon a first of the two bodies.

15. The method of claim 11, wherein relative motion between the two bodies causes a rotational force that moves the pipettes about an arcuate path.

16. The method of claim 11, wherein each of the pipettes are configured to generate a suctional force under the control of a corresponding plunger having a plunger cap located at a proximal end of the plunger, the method further comprising coupling each of the plunger caps to one another with an elongated member.

17. The method of claim 11, wherein the relative motion operates to exert force upon the pipettes, causing the pipettes to travel in two dimensions.

18. The method of claim 17, wherein the pipettes achieve at least two different substantially linear arrangements.

19. A pipetting device comprising:
a plurality of pipettes movably coupled to one another; and
a guide system configured to adjust an inter-pipette distance exhibited by the plurality of pipettes.

20. The pipette device of claim 19, wherein the guide system comprises at least two bodies configured to move relative to one another.
